(19) United States
(12) Patent Application Publication
(10) Pub. No.: US 2012/0072408 A1
(43) Pub. Date: Mar. 22, 2012

(54) METHOD AND SYSTEM OF PRIORITISING OPERATIONS

(75) Inventors: David Carmel, Haifa (IL); Haggai Roitman, Yoknea'm Elit (IL); Michal Shmueli-Scheuer, Ramat-Gan (IL); Yossi Mass, Ramat Gan (IL)

(73) Assignee: International Business Machines Corporation, Armonk, NY (US)

(21) Appl. No.: 13/305,758

(22) Filed: Nov. 29, 2011

Related U.S. Application Data
(63) Continuation of application No. 12/132,808, filed on Jun. 4, 2008, now Pat. No. 7,771,231.

(51) Int. Cl. G06F 17/30

(52) U.S. Cl. 707/709; 707/E17.014

(57) ABSTRACT

A method and system for prioritising operations on network objects are provided. The method includes gathering Web 2.0 available relationship data on the relationships between network entities, wherein network entities are network users and network objects. The relationship data for a network entity is analysed and a first relative score is determined based on the relationship data. For a network object, a second relative score is determined which is a dynamic score based on user interactions with the network object and formed using the first relative scores of network entities interacting with the object. The method then prioritizes an operation on a network object using the second relative score.

### CROSS-REFERENCE TO RELATED APPLICATIONS

This is a continuation of application Ser. No.12/432,808 filed on 30 Apr. 2009.

### FIELD OF THE INVENTION

This invention relates to the field of prioritising operations on network objects. In particular, the invention relates to prioritising operations on network objects using Web 2.0 available data.

### BACKGROUND OF THE INVENTION

The term “Web 2.0” refers to a perceived second generation of web development and design, that aims to facilitate communication, secure information sharing, interoperability, and collaboration on the World Wide Web. Web 2.0 concepts have led to the development and evolution of web-based communities, hosted services, and applications; such as social-networking, video-sharing, wilds, blogs, and folksonomies.

The sometimes complex and continually evolving technology infrastructure of Web 2.0 includes server-software, content-syndication, messaging-protocols, standards-oriented browsers with plugins and extensions, and various client-applications.

Web 2.0 websites typically include some of the following features/techniques.
Search—the ease of finding information through keyword search which makes the platform valuable.
Links—guides to important pieces of information. The best pages are the most frequently linked to.
Authoring—the ability to create constantly updating content over a platform that is shifted from being the creation of a few to being the constantly updated, interlinked work. In wilds, the content is iterative in the sense that the people undo and redo each other's work. In blogs, content is cumulative in that posts and comments of individuals are accumulated over time.
Tags—categorization of content by creating tags that are simple, one-word descriptions to facilitate searching and avoid rigid, pre-made categories.
Extensions—automation of some of the work and pattern matching by using algorithms.
Signals—the use of RSS (Really Simple Syndication) technology to notify users with any changes of the content, e.g., by sending e-mails to them.

Web 2.0 further introduced the notion of social networks which is a social structure made of nodes (which are generally individuals or organizations) that are tied by one or more specific types of interdependency, such as values, visions, ideas, financial exchange, friendship, kinship, dislike, conflict or trade.

In Web 2.0 users become not only consumers of information but also producers of data resulting in data which can be used to improve operations on web data objects.

### SUMMARY OF THE INVENTION

According to a first aspect of the present invention there is provided a method of prioritising operations on network objects, comprising: gathering Web 2.0 available relationship data on the relationships between network entities, wherein network entities are network users and network objects; analysing the relationship data for a network entity; determining for a network entity a first relative score based on the relationship data; determining for a network object a second relative score which is a dynamic score based on user interactions with the network object and formed using the first relative scores of network entities interacting with the object; and prioritising an operation on a network object using the second relative score; wherein any of said steps are implemented in either of computer hardware or computer software and embodied in a computer-readable medium.

The network entities may be web entities including web users and web objects or other entities available via a network.

The step of determining for a network object a second relative score includes may use the history of users' interactions with the object to provide the second relative score.

The step of determining for a network object a second relative score may include predicting users' interactions with the object to provide the second relative score.

The Web 2.0 available relationship data includes metadata generated by the network users and may include one or more of: social network data, folksonomy data, object authoring data, and object updating data.

In one embodiment, the step of prioritising an operation on a network object using the second relative score prioritises caching of network objects. The second relative score may be a dynamic score predicting the probability of future requests for cached network objects based on past users requests.

In another embodiment, the step of prioritising an operation on a network object using the second relative score prioritises crawling of network objects. The second relative score may be a dynamic score predicting where updates are likely to occur in network objects based on past user update patterns.

According to a second aspect of the present invention there is provided a computer program product for prioritising operations on network objects, the computer program product comprising: a computer readable medium; computer program instructions operative to: gathering Web 2.0 available relationship data on the relationships between network entities, wherein network entities are network users and network objects; analysing the relationship data for a network entity; determining for a network entity a first relative score based on the relationship data; determining for a network object a second relative score which is a dynamic score based on user interactions with the network object and formed using the first relative scores of network entities interacting with the object; and prioritising an operation on a network object using the second relative score; wherein said program instructions are stored on said computer readable medium.

According to a third aspect of the present invention there is provided a system for prioritising operations on network objects, comprising: a processor; a collector for gathering Web 2.0 available relationship data on the relationships between network entities, wherein network entities are network users and network objects; an analyzer for analysing the relationship data for a network entity; a module for determining for a network entity a first relative score based on the relationship data; a module for determining for a network object a second relative score which is a dynamic score based on user interactions with the network object and formed using the first relative scores of network entities interacting with the object; and a module for prioritising an operation on a network object using the second relative score; wherein any of said collector, analyzer, and modules are implemented in either of computer hardware or computer software and embodied in a computer readable medium.

The module for determining for a network object a second relative score may include using the history of users' interactions with the object obtained from a log to provide the second relative score.

The module for determining for a network object a second relative score may include predicting users' interactions with the object to provide the second relative score.

In one embodiment, the module for prioritising an operation on a network object using the second relative score prioritises caching of network objects. The second relative score may be a dynamic score predicting the probability of future requests for cached network objects based on past users requests.

In another embodiment, the module for prioritising an operation on a network object using the second relative score prioritises crawling of network objects. The second relative score may be a dynamic score predicting where updates are likely to occur in network objects based on past user update patterns.

According to a fourth aspect of the present invention there is provided a method of providing a service to a customer over a network of prioritising operations on network objects, the service comprising: gathering Web 2.0 available relationship data on the relationships between network entities, wherein network entities are network users and network objects; analysing the relationship data for a network entity; determining for a network entity a first relative score based on the relationship data; determining for a network object a second relative score based on a combination of the first relative scores of network objects and network users; and prioritising an operation on a network object using the second relative score; wherein any of said steps are implemented in either of computer hardware or computer software and embodied in a computer-readable medium.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a block diagram of a system in accordance with the present invention;

FIG. 2 is a block diagram of a computer system in which the present invention may be implemented;

FIG. 3 is a flow diagram of a method in accordance with the present invention;

FIG. 4 is a flow diagram of a method of caching in accordance with an aspect of the present invention; and

FIG. 5 is a flow diagram of a method of crawling in accordance with an aspect of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

A method and system are described of prioritising operations on network objects using Web 2.0 available data. Network objects include objects provided via a network. The network may be the Internet in which case the network objects are web objects, or an intranet, or other form of network in which Web 2.0 data is generated. Web objects may include web documents, web pages, etc. Web 2.0 available data includes, among others, social networks data (i.e., user to user relationships), and folksonomy or social indexing data (i.e., object to object and user to object relationships such as (tag, document), (user, document), (user, tag)).

The term network entities is used to include both network objects and network users who interact with the objects and therefore have relationships with the objects. The users may be individuals, automated computers, groups, organisations, etc.

Using an analysis the data Web 2.0 available data, the relative social rank can be obtained for each object and used to prioritize operations on the object, for example, data caching and gathering tasks.

Objects can be prioritised that are both important due to their static social rank and dynamic social rank. The dynamic social rank is obtained by examining the history of users that interact with the object and related objects.

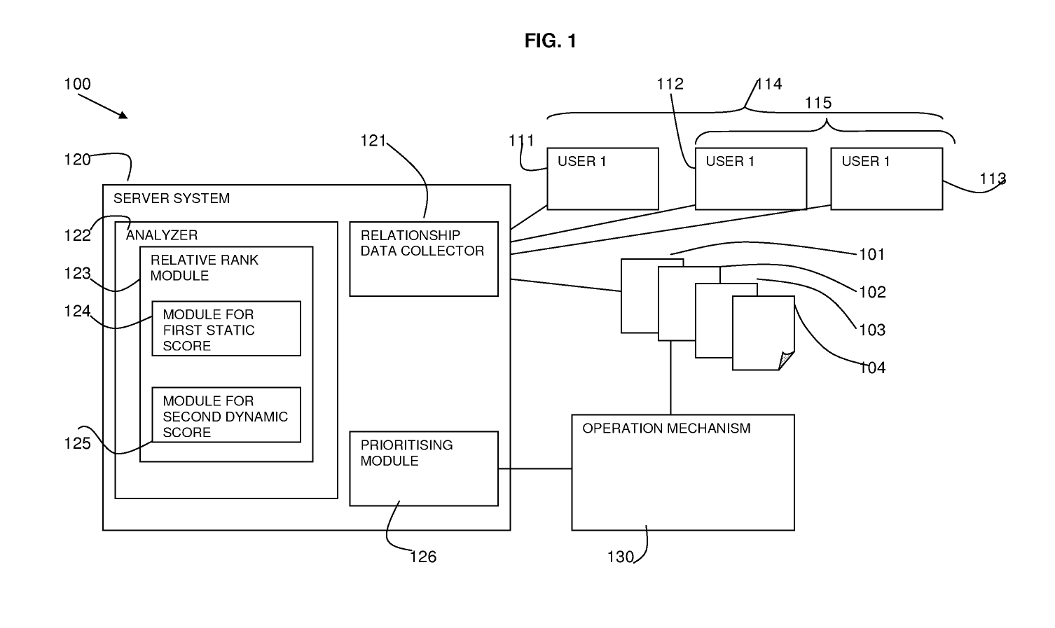

Referring to FIG. 1, a system 100 is provided for prioritising network objects 101-104 which may be objects available over a network, including the Internet, such as web documents, web pages, etc. Users 111-113 interact with each other and the network objects 101-104.

Web 2.0 includes new social network technology and object and user interaction which can be used as metadata and used to rank or score the importance of network objects and users.

The users' 111-113 interaction with each other is defined by social networks 114, 115. A social network is a social structure made of nodes of users (which are generally individuals or organizations) that are tied by one or more specific types of interdependency, such as values, visions, ideas, financial exchange, friendship, kinship, dislike, conflict, trade, familiarity, similarity, or any kind of implicit relationship.

The objects 101-104 have relationships to other objects and to users 111-113 which are defined by folksonomies, authoring, updating, and other means.

The combined data from Web 2.0 sources relating to the relationships between users 111-113, objects 101-104, and users and objects is referred to as relationship data.

A server system 120 is described including a relationship data collector 121 and an analyser 122 of the relationship data for an object. The analyser 122 includes a relative rank module 123 for rating the relative rank of objects.

The relative rank module 123 includes a module 124 for determining for entities (both web objects and web users) a first relative score which is a static score for the entity. The relative rank module 123 includes a module 125 for determining for network objects a second relative score which is a dynamic score based on user interaction with the object. The system 120 also includes a prioritising module 126 for prioritising objects based on the relative rank.

The objects 101-104 are operated on by some form of operation mechanism 130 using the prioritisation of the prioritising module 126. The operation mechanism 130 may be, for example, a web caching mechanism, or a content management mechanism.

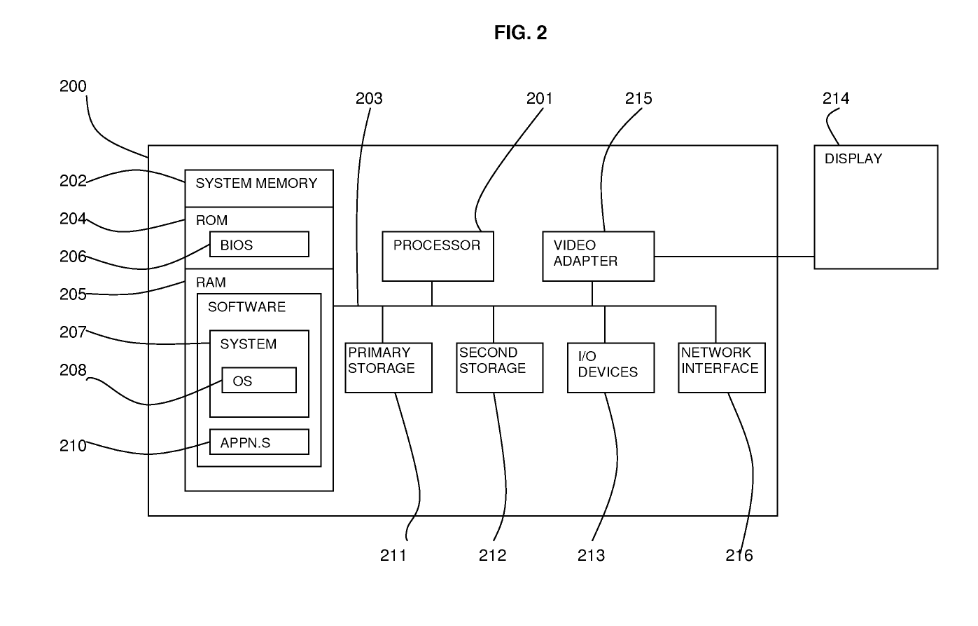

Referring to FIG. 2, an exemplary system for implementing aspects of the invention includes a data processing system 200 suitable for storing and/or executing program code including at least one processor 201 coupled directly or indirectly to memory elements through a bus system 203. The memory elements can include local memory employed during actual execution of the program code, bulk storage, and cache memories which provide temporary storage of at least some program code in order to reduce the number of times code must be retrieved from bulk storage during execution.

The memory elements may include system memory 202 in the form of read only memory (ROM) 204 and random access memory (RAM) 205. A basic input/output system (BIOS) 206 may be stored in ROM 204. System software 207 may be stored in RAM 205 including operating system software 208. Software applications 210 may also be stored in RAM 205.

The system 200 may also include a primary storage means 211 such as a magnetic hard disk drive and secondary storage means 212 such as a magnetic disc drive and an optical disc drive. The drives and their associated computer-readable media provide non-volatile storage of computer-executable instructions, data structures, program modules and other data for the system 200. Software applications may be stored on the primary and secondary storage means 211, 212 as well as the system memory 202.

The computing system 200 may operate in a networked environment using logical connections to one or more remote computers via a network adapter 216.

Input/output devices 213 can be coupled to the system either directly or through intervening I/O controllers. A user may enter commands and information into the system 200 through input devices such as a keyboard, pointing device, or other input devices (for example, microphone, joy stick, game pad, satellite dish, scanner, or the like). Output devices may include speakers, printers, etc. A display device 214 is also connected to system bus 203 via an interface, such as video adapter 215.

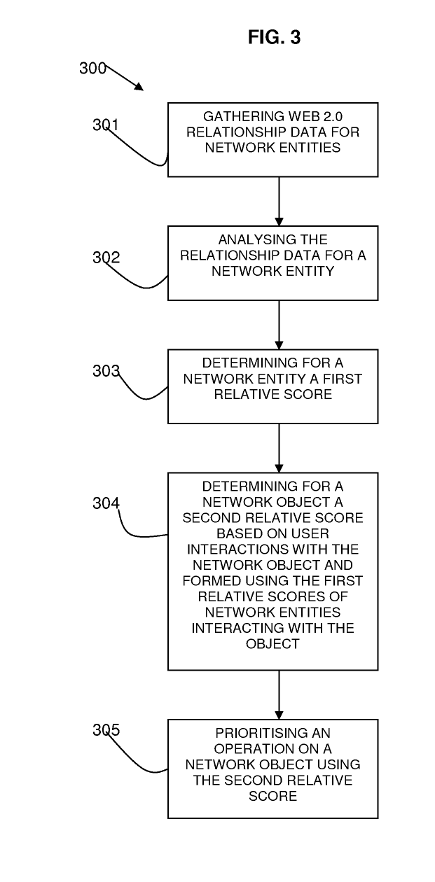

Referring to FIG. 3, a flow diagram 300 shows the described method. Web 2.0 available relationship data is gathered 301 for relationships between network entities. The network entities include network objects and network users and the relationships may be user to user, object to object, or user to object.

The gathered relationship data is analyzed 302 for a network entity. A first relative score is determined 303 for a network entity which is a static score based on the importance of the network entity, which may be a user or an object. A second relative score is then determined 304 for a network object which is a dynamic score based on user interactions with the object and formed using the first relative scores of entities interacting with the object.

An operation on a network object, such as caching or crawling, is prioritized 305 using the second relative score.

In a first described embodiment, the operation is data caching and a new caching policy is built on the prioritisation.

In a second described embodiment, the operation is data crawling and, there is another added value which is described which is the usage of users' update patterns as part of the crawling strategy, where the crawler can use the identity of users and the social networks overlays to predict where updates may occur (e.g., by finding similar users that share similar update (rate+content based) patterns to a user whose update was discovered by the system).

A first embodiment is described in the context of web caching. Web 2.0 requires an increasing bandwidth consumption to transfer large multimedia objects (for example, video and high resolution photos). A common solution to this problem is web caching.

Improved caching performance of a content management system can be obtained by utilizing the additional metadata that can be derived using social networks analysis. Using social networks ranking techniques, a new caching policy is described that is “social sensitive”. Hence, the described policy ranks each object in the cache by its relative importance as derived using social networks analysis.

The object's rank combines both the object's own rank and the rank of users that request the object in the system. Therefore, an object that is more important and is requested by more important “authoritative” users in the system is predicted to be more important and has higher chance to be requested in the future. The described caching policy can be referred to as “Least Socially influencing First (LSIF)”. The proposed caching policy may also be used to boost other existing caching policies.

A described caching policy predicts the probability of future requests for objects managed by the cache management system based on both dynamic and static statistical data gathered from analysis of social networks that exist within different communities of a content management system or outside of it.

The caching policy assigns each object a combination of static and dynamic scores. The static score of an object within the cache is determined by the relative rank of the object as derived from social networks analysis. For example, the object's FolkRank in a Folksonomy analysis such as described in A. Hotho, R. Jaschke, C. Schmitz, G. Stumme, “FolkRank: A Ranking Algorithm for Folksonomies”; its HubRank as described in S. Chakrabati, “Dynamic Personalized PageRank in Entity-Relation Graphs, WWW 2007, or its EntityRank as derived from a Multi-Entity Graph analysis as described in T. Cheng, X. Yan, K. C. C. Chang, “EntityRank: Searching Entities Directly and Holistically”.

The dynamic score of an object predicts the probability of future requests for the object by other users in the system that may be influenced by other more authoritative users that requested the object in the past. This probability is determined using a log analysis of the history of previous requests for the object by different users in the system and estimating each user's relative authority in the system as derived from an analysis of the user's social networks or folksonomy data (For example, determined by user's FolkRank or HubRank in the system).

This dynamic score follows the following basic principle: Given two objects in the cache O1 and O2 that were requested by users U1 and U2 respectively, then if user U1 is more authoritative than user U2 (as derived from the analysis of the users' social networks or folksonomy data), then O1 is predicted to be more qualitative then O2 in the system (i.e. voted as a better object by a more important user in the system).

Thus, the requesting user's relative authority in the system implies more chance of a recommendation for the object (or voting) by these users to other (less authoritative) users in their social networks (i.e., propagation of recommendations about the object in the social network). Therefore, an object that has more authoritative users requesting it, is predicted to be more likely required by more users that relate to those more authoritative users that requested the object in the past and may propagate recommendations to other less authoritative users.

Metadata gathered from an analysis of the system's social networks (e.g., Multi-Entity Graph analysis or Folksonomy analysis) is used to derive for each entity in the system (either user or object) its relative rank in the system (herein denoted as SocialRank). For each object in the system, the following metadata is maintained:
Static metadata: SocialRank(O) of the object (social) rank in the system.
Dynamic metadata: H(O): a log that contains the request history of each object in the system.
For each entry in the log, the following data is kept:
   Requester user id (Ui)
   SocialRank(Ui) of the user in the system.
   The id of requested object (Oj)
   The object request time tk

The static part of an object Oj score (S(Oj)) in the cache is calculated as the relative (normalized) rank of the object as derived from the social networks analysis:

$$S ( {O}_{j} ) = \frac{SocialRank ( {O}_{j } )}{{\sum }_{{O}_{j} ∈ Cache} SocialRank ( {O}_{j} )}$$

The dynamic part of an object Oj score (D(Oj)) in the cache is calculated as the relative rank of the object as derived from the history of requests for the object in the system's log by different users and their relative rank as derived from the social networks analysis.

$$D ( {O}_{j} ) \frac{{\sum }_{i ∈ H ( {O}_{j} )} SocialRank ( {U}_{i} )}{{\sum }_{{O}_{j} ∈ Cache} {\sum }_{i ∈ H ( {O}_{j} )} SocialRank ( {U}_{i} )}$$

The time of requests can also be utilized to further refine the dynamic score to consider also the decay in object's relative importance among different users in the system (for example, as time passes by from the object request time by some user, there is less chance for propagation of recommendations about the object by that user to other users in his social network that rank this user as more authoritative). Furthermore, the more authoritative the user, the decay is longer.

$$D ( {O}_{j} ) = \frac{{\sum }_{i ∈ H ( {O}_{j} )} {e}^{{SocialRank ( {U}_{i} )}^{- 1} ( {t}_{k} - t )}}{{\sum }_{{O}_{j} ∈ Cache} {\sum }_{i ∈ H ( {O}_{j} )} {e}^{{SocialRank ( {U}_{i} )}^{- 1} ( {t}_{k} - 1 )}} , \\ where t is current system$$

time.

Finally, calculate the object's score in the cache as:

Score(Oⱼ)=S(Oⱼ)×D(Oⱼ)

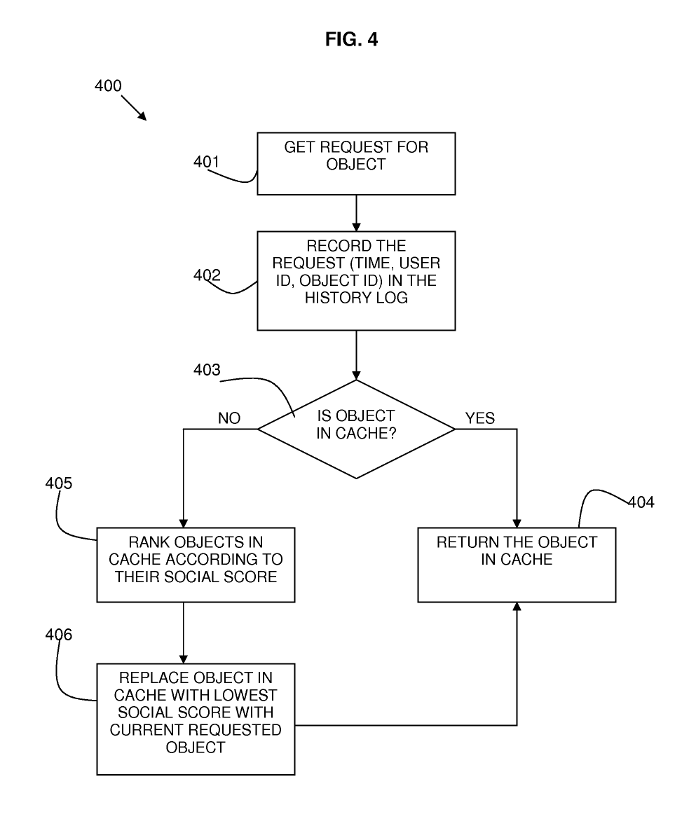

Referring to FIG. 4, a flow diagram 400 shows a method of caching an object. A request for an object is received 401 and a record is made 402 of the request (time, user ID, object ID) in the history log. It is determined 403 if the object is in the cache. If so return 404 the object in the cache. If not, rank 405 objects in the cache according to their social score, and replace 406 the object in the cache with the lowest social score with the current requested object. Then return 404 the object in the cache.

Using the new definition of object score in the cache, a new cache placement/replacement policy is defined, which may be termed: “Least Socially influencing First (LSIF)”, where an object with the current lowest social score in the cache is picked for replacement.

The described method measures the importance of an object based on social network analysis (for example, the object folkrank, hubrank, etc.). Such analysis is based on folksonomy analysis which considers users and objects and the relationships among them to calculate the overall (static) score of an object. This score is SocialRank of the object.

The method further uses the same social analysis to determine the importance of the users that submit requests to the content management system. This importance implies the authority of different users in the system. This user importance is the SocialRank of the user that requests objects.

Using the SocialRank measure both for requested objects and for the users that request different objects two scores are calculated for each object managed in the system. The first is a static score based on the object own SocialRank in the system. The second is a dynamic score which is based on the request history to each object in the system by different users. The premise is that an object that has more requests by more authoritative users is a more important object and that such an object has more chance to be requested in the future by follower users of authoritative users that already requested the object.

Both static and dynamic scores are then combined to a single unified object importance measure.

A second described embodiment is in the context of data crawling. Many applications use crawlers to crawl all or parts of the web. For example, a web search engine needs to continuously crawl the web to maintain an updated index of the web. There are three important characteristics of the web that generate a scenario in which web crawling is very difficult: its large volume, its fast rate of change, and dynamic page generation. The large volume implies that the crawler can only download a fraction of the web pages within a given time, so it needs to prioritize its downloads.

Traditional web crawlers try to devise policies to predict which pages should be crawled at a given time. The policies are based on estimating freshness of a page based on its past change rate. For each page p the rate of changes (denoted λₚ) is associated. The rate of changes could be based on some statistics from a web server (such as last modification time) or by comparing copies of the same page at different time stamps. Based on this, the crawler can estimate how “fresh” is the copy of each page, and to advise the best re-visiting order in order to maximize the freshness on the entire web.

In Web 2.0 users become not only consumers of information but also producers of data, thus page updates are no more “black box” or some “system updates”, but rather, updates could be easily associated with users. Bloggers update their blogs regularly at the rate of over 1.6 million posts per day, or over 18 updates a second.

Traditional web crawlers that look only at past page updates, but ignore the authority of users that updated the pages, and ignore the social networking of those users that updated similar pages, can not optimize their policies for such an environment.

A method is described for predicting a “virtual” page update rate that can be used by web crawlers, web monitoring or other information gathering applications. The method leverages social networks to predict future update rates for a page by considering importance of users, their past updates to pages and past updates of similar pages by the social networks of those users.

The method targets users as the main source of content updates to web pages instead of the common traditional assumption that updates are made by some content management system (i.e., the server that manages the content).

Metadata about users' updates to web pages is used which is becoming more and more available (e.g., by extracting taggers' identities from Flicker pages) and metadata that is extracted from social network analysis (e.g., connections among different users that updated pages).

At any given point of time, for every page which information is needed to be gathered, two disjoint subsets of users are first identified: users that already have updated the page in the past and those who have not.

A page importance is determined using the metadata about the update rates of users that updated the page up to that time point (using the metadata of user update timestamps) to that page. Using these users relative importance in the social network (using the metadata about the users social network) its marginal contribution to the direct update rate of the page relative to the user's update rate and the user's social importance (i.e., authority) is calculated for each such user.

For every user that updated the page, the potential contribution to the page importance by indirect users that have connections to users that already updated the page is considered. This potential contribution is calculated by looking at other pages that were updated by those indirect users and examining both the update rates in which these users update those pages and the level of similarity these pages have with the current page.

Therefore, if the page has many indirect users that have strong connection to users that already updated the page and are important users (determined from the social networks metadata) and have high update rates for similar pages to this page, this page will be considered as more important.

That means that the page has a higher predicted chance to be updated by other users that have not updated this page yet in the past but share high similarity with users that have already updated this page and probably since those users update pages that are similar to the current page, they might update also the page in the future.

The importance of each page is determined using the following four principles:
A page that is updated more frequently is more important.
A page that is updated by more important users is more important.
A page has a potential to be updated in the future by users that are friends (or “followers”) of users that already updated this page in the past.
A user that updates other pages that are similar in their content to a page that hasn't been updated by this user in the past, is a potential user for updating this page in the future.

The four principles can be intuitively justified by the following scenarios:
Pages that are updated more frequently need more crawls to maintain a fresh version (assuming that every single update to a page is important).
A page that gets updated by a popular (or authoritative) user, may have a better chance to get other users reading the contribution of that important user and may be willing to contribute also content to that page, e.g., commenting about some expert user's blog posting.
A social relationship between two users, having one user that already updated the page and the other user who didn't, may be used to imply how close is the last user to the first one with respect to their common interests. For example, a social network based on interests on some topic X between a user that already updated the page and one that didn't may imply about the chance that the page that belong to the same topic X may be updated in the future by the last user.
Users usually have a limited scope of interests (which define their user profile). The history of updates to pages by users that didn't update yet some page and their similarity of those pages to that page can imply how much chance that page has to be update also by those users.

A set of pages P is assumed that are updated over time by a set of users U that further construct a social network (SN).

For every page p in P and every time point t, two disjoint sets of users are identified with regard to page p:
Uₜ(p): subset of users in U that have updated pages p at least once up to time t.
Ūₜ(p)=U\Uₜ(p): the subset of users in U that did not update page p up to time t.
Note that over time, users shift from Uₜ(p) to Ūₜ(p), where initially Uₜ(p) is empty for every page p in P.

For each user u in Uₜ(p), the update rate of this user is measured to page p (denote: λₚ^{u}(t)) taken as the total number of updates of user u to page p up to time t divided by t (assuming uniform update rate).

Therefore, if λₚ(t) denotes the update rate of page p at time t, then the general update rate of page p is given by: λₚ(t)=Σ_{uεU}_{ₜ}₍ₚ₎λₚ^{u}(t).

For every user in U, assume the availability of user u relative importance (or authority) in the social network at time t (ωₜ(u)).

Such authority can be calculated by known methods, for example, using methods described in one of: A. Hotho, R. Jaschke, C. Schmitz, G. Stumme, “FolkRank: A Ranking Algorithm for Folksonomies”; S Chakrabati, “Dynamic Personalized PageRank in Entity-Relation Graphs, WWW 2007; or T. Cheng, X. Yan, K. C. C. Chang, “EntityRank: Searching Entities Directly and Holistically”, VLDB 2007.

Given a subset U′ of users in U, further denote

$${\overline{ω}}_{t} ( u , {U}^{′} ) = \frac{{ω}_{t} ( u )}{{\sum }_{u ∈ {U}^{′}} {ω}_{r} ( u )}$$

the normalized authority (number in [0,1]) of user u relative to the subset U′.

Given two users u and u′ in U, denote ψₜ(u,u′)=dist(u, u′,SN) the degree of relatedness between the two users with respect to the social network SN generated by connections among the different users in U (in this case this relatedness is taken as the distance in terms of number of connections between users in the path from user u to user u′ in the social network SN).

Given Ūₜ(p), further denote

$${\overline{ψ}}_{p , t} ( u , {u}^{′} ) = \frac{{{ψ}_{t} ( u , {u}^{′} )}^{- 1}}{{\sum }_{{u}^{′} ∈ {\overline{U}}_{t} ( p )} {{ψ}_{t} ( u , {u}^{′} )}^{- 1}}$$

the relative relatedness of user u′ to user u in the social network SN, normalized over all users in Ūₜ(p). Further, take the power of −1 in ψₜ(u,u′) to denote that as the two users are more distant in the social network, the less is the relatedness degree between them (and therefore, the less this relatedness should be considered).

For every user u in U we keep the set of pages that user u has updated up to time t: Pₜ(u).

For every two pages p and p′ in P we denote simₜ(p,p′) the similarity between page p and page p′ at time t.

Such page similarity can be taken, for example, in terms of content similarity between the two pages (e.g., using vector space similarity).

Given two pages p and p′ in Pₜ(u) of some user u in U, denote

$${\overline{sim}}_{u , t} ( p , {p}^{′} ) = \frac{{sim}_{t} ( p , {p}^{′} )}{{\sum }_{{p}^{″} ∈ {P}_{t} ( u )} {sim}_{t} ( p , {p}^{″} )}$$

the normalized similarity between the two pages taken over all the pages in Pₜ(u).

Determining a Page Importance for Information Gathering

Let φₚ(t) be the estimated importance of page p at time t. At each time point t, calculate the importance of every page p in P, φₚ(t) using the following formula:

$${φ}_{p} ( t ) = {\sum }_{u ∈ {U}_{t} ( p )} ( \begin{matrix}{\overline{ω}}_{t} ( u , {U}_{t} ( p ) ) \times {λ}_{p}^{u} ( t ) + \\ {\sum }_{{u}^{′} ∈ {\overline{U}}_{t} ( p )} ( \begin{matrix}{\overline{ψ}}_{p , t} ( u , {u}^{′} ) \times {\overline{ω}}_{t} ( {u}^{′} , {\overline{U}}_{t} ( p ) ) \times \\ {\sum }_{{p}^{′} ∈ {P}_{t} ( {u}^{′} )} {λ}_{{p}^{′}}^{{u}^{′}} ( t ) \times {\overline{sim}}_{{u}^{′} , t} ( p , {p}^{′} )\end{matrix} )\end{matrix} )$$

### Therefore:

At time t, first consider the set of users in Uₜ(p) that already updated page p up to time t. Consider each user's u in Uₜ(p) marginal contribution to the importance of page t by looking at the combination update rate of user u to page p λₚ^{u}(t) (which represent user's u marginal contribution to updates of p) and user's u relative importance (authority) ω̅ₜ(u,Uₜ(p))over the set of users that updated page p. Therefore, an update of page p by a user that is more authoritative and/or contributes more frequently to the update rate of page p is considered more important then an update of a user that is less authoritative and/or contributes less frequently to the update rate of page p.

For every direct user u that updated page p up to time t we further predict a potential increase in page p importance by indirect users u′ in Ūₜ(p) that did not update page p up to time t but have some degree of relatedness to user u (who did update page p).

For those users u′ in Ūₜ(p), further consider the combination of the relative degree of similarity between page p and other pages p′ in Pₜ(u′) that were updated up to time t by u′, s̅i̅m̅_{u′,t}(p,p′), and the update rate of u′ to these pages λ_{p′}^{u′}(t). Therefore,

$${\sum }_{{p}^{′} ∈ {P}_{t} ( {u}^{′} )} {λ}_{{p}^{′}}^{{u}^{′}} ( t ) \times {\overline{sim}}_{{u}^{′} , t} ( p , {p}^{′} )$$

presents a virtual predicted update rate of user u′ to page p at some time after time t by considering similar pages to page p (up to some degree) and the rate of update of user u′ to these pages.

Further multiply each such user u′ future predicted contribution to page p importance in user u′ relative importance among the users in Ūₜ(p) and user u′ relative degree of relatedness to user u ψ̅_{p,t}(u,u′)× ω̅ₜ(u′,Ūₜ(p)).

Therefore, a page that has users u that updated it and have stronger relationships (with respect to their social network) with other authoritative users u′ that did not update page p yet but update similar pages very often, is predicted as a page that has a higher chance of getting update in the future by those indirect users u′, and therefore, is more important.

Policy for Information Gathering

Using the suggested method for determining a page importance for information gathering, several different policies can be constructed.

As an example, one can consider a greedy policy, where the order on which information is gathered from the different pages is determined by the importance of each page as given above. Therefore, given the set of pages in P and the current time is t, the next page revisit policy would be determined by sorting the pages in P relative to φₚ(t) and scheduling page crawls according to the resulting order.

As another example, one can consider to allocate page crawls according to the relative importance of page p φₚ(t) compared to other pages. Therefore, given that there are n pages in P and m<<n allocations for page crawl tasks in some time period T, each page p is allocated with

$$m \times \frac{{φ}_{p} ( t )}{{\sum }_{p ∈ P} {φ}_{p} ( t )} page crawls .$$

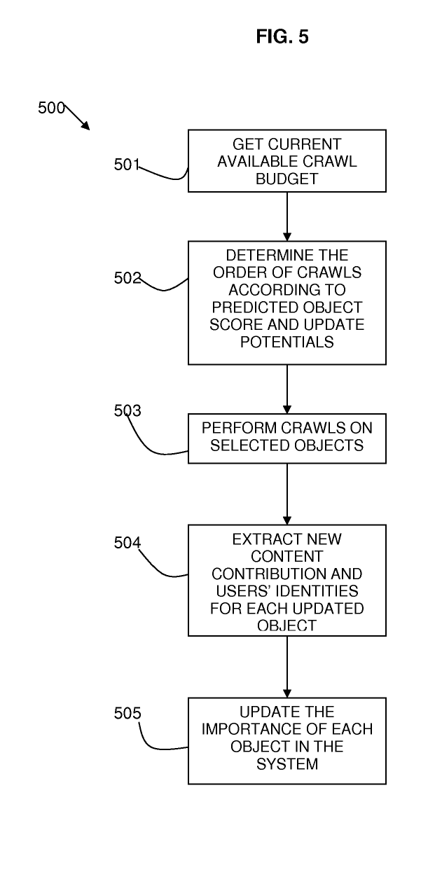

Referring to FIG. 5, a flow diagram 500 shows a method of crawling. The method starts by getting 501 the current available crawl budget. Next, determine 502 the order of crawls according to predicted object score and update potentials. Then perform crawls 503 on selected objects and extract 504 new content contribution and user identities for each updated object. Update 505 the importance of each object in the system and return to the start.

The described web information gathering method (i.e., to be used by web monitors or web crawlers) uses social network overlays in order to discover potential of new updates to different resources in the system according to similarity between different users in the system (“resource updaters”) and the content that they contribute in the system. The identity of update sources are not hidden and for many systems those identities are of users that contribute content in the system. Therefore, such metadata is leveraged to improve existing web information gathering methods.

A prioritising system for network objects may be provided as a service to a customer over a network.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

What is claimed is:

1. A method for prioritizing a web crawling operation, the method comprising:
calculating an importance score of a first data object as a function of
a update rate at which said first data object is updated by a first user, and
a social rank score of said first user; and
establishing, as a function of said importance score, a priority with which said first data object is to be crawled.

2. The method according to claim 1 and further comprising calculating said importance score of said first data object as a function of
an update rate at which said first data object is updated by a second user, and
a social rank score of said second user.

3. The method according to claim 1 and further comprising performing a crawling operation on said first data object prior to performing a crawling operation on a second data object if said priority established for said first data object is higher than a priority established for said second data object.

4. The method according to claim 1 and further comprising:
establishing a budget of crawling operations; and
performing, in accordance with said budget, a greater number of crawling operations on said first data object than on a second data object if said priority established for said first data object is higher than a priority established for said second data object.

5. The method according to claim 1 and further comprising adding a predictive factor to said importance score wherein said predictive factor is derived from a social network of which said first user is a member.

6. The method according to claim 5 wherein said predictive factor is a function of
an update rate at which a second data object is updated by a second user, and
a social rank score of said second user.

7. The method according to claim 6 wherein said calculating and establishing steps are performed prior to said second user updating said first data object.

8. The method according to claim 6 wherein said predictive factor is a function of a measure of relatedness between said first user and said second user.

9. A method according to claim 6 wherein said predictive factor is a function of a measure of similarity between said first data object and said second data object.

10. A system for prioritizing a web crawling operation, the system comprising:
an analyzer configured to calculate an importance score of a first data object as a function of
a update rate at which said first data object is updated by a first user, and
a social rank score of said first user; and
a prioritizing module configured to establish, as a function of said importance score, a priority with which said first data object is to be crawled.

11. The system according to claim 10 wherein said analyzer is further configured to calculate said importance score of said first data object as a function of
an update rate at which said first data object is updated by a second user, and
a social rank score of said second user.

12. The system according to claim 10 wherein said prioritizing module is further configured to perform a crawling operation on said first data object prior to performing a crawling operation on a second data object if said priority established for said first data object is higher than a priority established for said second data object.

13. The system according to claim 10 wherein said prioritizing module is further configured to establish a budget of crawling operations, and perform, in accordance with said budget, a greater number of crawling operations on said first data object than on a second data object if said priority established for said first data object is higher than a priority established for said second data object.

14. The system according to claim 10 wherein said analyzer is further configured to add a predictive factor to said importance score wherein said predictive factor is derived from a social network of which that said first user is a member.

15. The system according to claim 14 wherein said predictive factor is a function of
an update rate at which a second data object is updated by a second user, and
a social rank score of said second user.

16. The system according to claim 15 wherein said analyzer is configured to perform said calculating step prior to said second user updating said first data object, and wherein said prioritizing module is configured to perform said calculating step prior to said second user updating said first data object.

17. The system according to claim 15 wherein said predictive factor is a function of a measure of relatedness between said first user and said second user.

18. A system according to claim 15 wherein said predictive factor is a function of a measure of similarity between said first data object and said second data object.

19. A computer program product for building an expression, the computer program product comprising:
a computer-readable storage medium; and
computer-readable program code embodied in the computer-readable storage medium,
where the computer-readable program code is configured to
calculating an importance score of a first data object as a function of
a update rate at which said first data object is updated by a first user, and
a social rank score of said first user; and
establishing, as a function of said importance score, a priority with which said first data object is to be crawled.

20. The computer program product according to claim 19 where the computer-readable program code is configured to calculate said importance score of said first data object as a function of
an update rate at which said first data object is updated by a second user, and
a social rank score of said second user.

21. The computer program product according to claim 19 where the computer-readable program code is configured to perform a crawling operation on said first data object prior to performing a crawling operation on a second data object if said priority established for said first data object is higher than a priority established for said second data object.

22. The computer program product according to claim 19 where the computer-readable program code is configured to
establish a budget of crawling operations; and
perform, in accordance with said budget, a greater number of crawling operations on said first data object than on a second data object if said priority established for said first data object is higher than a priority established for said second data object.

23. The computer program product according to claim 19 where the computer-readable program code is configured to add a predictive factor to said importance score wherein said predictive factor is derived from a social network of which said first user is a member.

24. The computer program product according to claim 23 wherein said predictive factor is a function of
an update rate at which a second data object is updated by a second user, and
a social rank score of said second user.

25. The computer program product according to claim 24 where the computer-readable program code is configured to perform said calculating and establishing prior to said second user updating said first data object.
